(19) United States
(12) Patent Application Publication
(10) Pub. No.: US 2005/0017087 A1
(43) Pub. Date: Jan. 27, 2005

(54) Conduit intersection for high pressure fluid flow

(76) Inventors: Brent Brower, Byron Center, MI (US); Michael Weston, Lawrence, MI (US); Tanveer Singh, Kentwood, MI (US); John T. Haworth, Alto, MI (US)

Correspondence Address: MCGARRY BAIR PC, 171 MONROE AVENUE, N.W., SUITE 600, GRAND RAPIDS, MI, 49503, US

(21) Appl. No.: 10/501,274

(22) PCT Filed: Nov. 19, 2002
(86) PCT No.: PCT/US02/37038

(51) Int. Cl. F02M 47/02

(52) U.S. Cl. 239/88; 138/39; 239/533.2; 239/533.3

(57) ABSTRACT

A body (30) having a conduit (38) adapted for fluid flow under high pressure includes a first passageway (32) having a first longitudinal (33) axis and second passageway (34) having a second longitudinal axis (35). The first and second longitudinal axes intersect each other at an angle. An enlarged generally spherical cavity (36) having a center point (42) at the intersection of the first and second longitudinal axes reduces stress on the walls of the conduit. Particular application is found in a fuel distribution system for an internal combustion engine.

### BACKGROUND OF THE INVENTION

1. Field of the Invention

The invention relates generally to metal bodies with conduits for high-pressure fluid flow. More particularly, the invention relates to angular intersections of high-pressure fluid flow conduits.

2. Description of the Related Art

Various applications utilize conduits in metal bodies for fluid flow under high pressure. Often those conduits comprise two or more passageways that are angled with respect to one another. For example, fuel distribution systems with fuel injectors are employed in internal combustion engines for delivering a predetermined, metered amount of fuel to the combustion chamber at preselected intervals. In the case of compression ignition, or diesel engines, the fuel is injected into the combustion chamber at relatively high pressures. Presently, conventional injectors are delivering this fuel at pressures on the order of 29,000 psi (2,000 bar). Often the conduits for delivery of fuel under pressure have one or more turns so that the passageways in the conduit are angled with respect to one another.

Illustrations of the intersections such conduits may employ are seen in FIGS. 1-3a. Looking first at FIG. 1, for example, a metal body 10 has within it a conduit 12 comprising a first passageway 14 and a second passageway 16. The first and second passageways 14, 16 are at an angle with respect to each other, forming an elbow intersection 18. The conduit 12 is typically formed by drilling into the body 10 to form each passageway 14, 16 and to form the intersection 18 where the passageways meet. Natural consequences of this operation at the intersection 18 include sharp corners and burrs. Thus, a second operation will normally use electrochemical machining (ECM) to smooth and blend the passageways 14, 16 at the intersection 18, typically resulting in a radius 20 at the inside angle and a radius 22 at the outside angle of the intersection 18. FIG. 2 shows a conduit 12 with an intersection 18 similar to that of FIG. 1, except that the angle between the passageways 14, 16 is closer to 90°. In FIG. 3, a T-intersection 18 between passageways 14, 16 provides two inside radiuses 24, 26.

It will be understood that a cross section of a passageway is normally circular. However, it can be seen in FIGS. 1a, 2a and 3a that a cross section taken at the intersection 18 is not circular, but elliptical. Generally, the more acute the inside angle between two passageways 14, 16, the more elongated the elliptical cross section at the intersection 18. A known problem at such intersections is the failure of the body 10 resulting from the high pressures induced by fluid. Such failures are evidenced by cracks that form at inside radiuses 20, 24, 26. It is believed that such failures are due to uneven distribution of stress due to fluid pressure against the conduit wall at the intersection where the cross-sectional area is not circular. Finite element analysis of a typical case has shown stresses on an inside radius at a 90° intersection with fluid pressures of 29,000 psi (2000 bar) as high as 850 MPa or 123 KSI.

Such failures become even more critical in fuel injectors as increasing demands on greater fuel economy, cleaner burning, fewer emissions, and NOₓ controls have placed, and will continue to place, even higher demands on the engine's fuel delivery system including increasing the fuel pressure within the injector.

There is a need for a solution to the problems arising from angled intersections in high-pressure fluid flow conduits. One obvious solution is to design bodies without angled intersections. However, size and weight in designs utilizing high pressure conduits without angles often come at a high cost, rendering them commercially unviable.

### SUMMARY OF THE INVENTION

A solution to these and other problems is found in an improvement for any body with a high-pressure fluid conduit formed of a first passageway having a first longitudinal axis and second passageway having a second longitudinal axis, where the first and second longitudinal axes intersect at an angle other than 180 degrees. The improvement lies in an enlarged cavity having a center point at the intersection of the first and second longitudinal axes.

Preferably the enlarged cavity is generally spherically shaped, and the diameter of the cavity is at least twice the cross sectional diameter of one of the first and second passageways. In one aspect, the angle between the first and second passageways is about 90 degrees.

In another aspect of the invention, a method is described for manufacturing a body having a conduit with a first passageway having a first longitudinal axis and second passageway having a second longitudinal axis, where the first and second longitudinal axes intersect at an angle other than 180 degrees. The conduit also has an enlarged cavity having a center point at the intersection of the first and second longitudinal axes. The method includes the steps of drilling the first passageway into the body along a first longitudinal axis, drilling the second passageway into the body along the second longitudinal axis until the second longitudinal axis intersects the first longitudinal axis, and then utilizing electromechanical machining to remove material from the walls of the first and second passageways adjacent the intersection of the first and second longitudinal axes until the enlarged cavity is formed with a center point at the intersection.

Preferably, the step of utilizing electromechanical machining includes removing material evenly in all directions to form a spherical cavity. Also, material can be removed in all directions until the diameter of the cavity is at least twice the diameter of the first or the second passageway.

The invention has particular applicability in the field of fuel distribution systems for fuel injectors.

### DESCRIPTION OF THE DRAWINGS

FIG. 1 is a cross sectional side view of a prior art high-pressure conduit in a body.

FIG. 1a is a cross sectional view of the conduit of FIG. 1 taken along lines 1a-1a.

FIG. 2 is a cross sectional side view similar to FIG. 1 of another embodiment of a prior art high-pressure conduit in a body.

FIG. 2a is a cross sectional view of the conduit of FIG. 2 taken along lines 2a-2a.

FIG. 3 is a cross sectional side view similar to FIGS. 1 and 2 of third embodiment of a prior art high-pressure conduit in a body.

FIG. 3a is a cross sectional view of the conduit of FIG. 3 taken along lines 3a-3a.

FIG. 4 is a cross sectional side view of a high-pressure conduit in a body according to the invention.

FIG. 4a is a cross sectional view of the conduit of FIG. 4 taken along lines 4a-4a.

FIG. 5 is a cross sectional side view similar to FIG. 4 of another embodiment of a high-pressure conduit in a body according to the invention.

FIG. 5a is a cross sectional view of the conduit of FIG. 5 taken along lines 5a-5a.

FIG. 6 is a cross sectional side view similar to FIGS. 4 and 5 of a third embodiment of a high-pressure conduit in a body according to the invention.

FIG. 6a is a cross sectional view of the conduit of FIG. 6 taken along lines 6a-6a.

FIG. 7 is a schematic view of a fuel distribution system with a high-pressure conduit according to the invention.

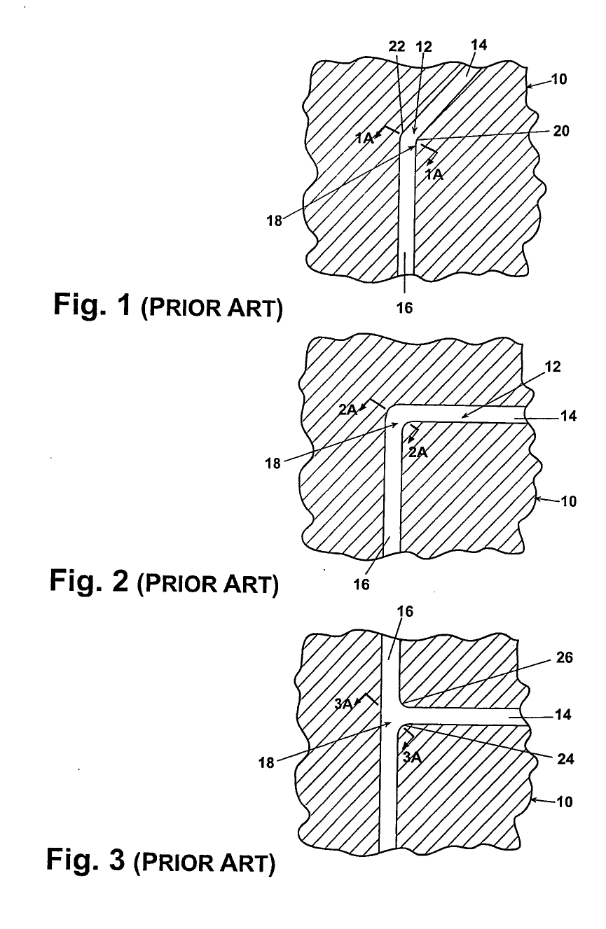

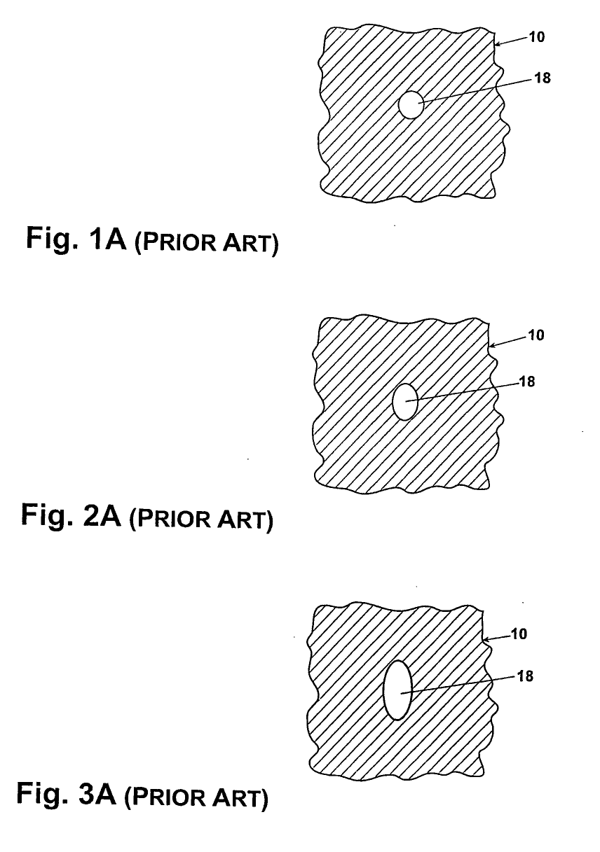

### DESCRIPTION OF THE PREFERRED EMBODIMENTS

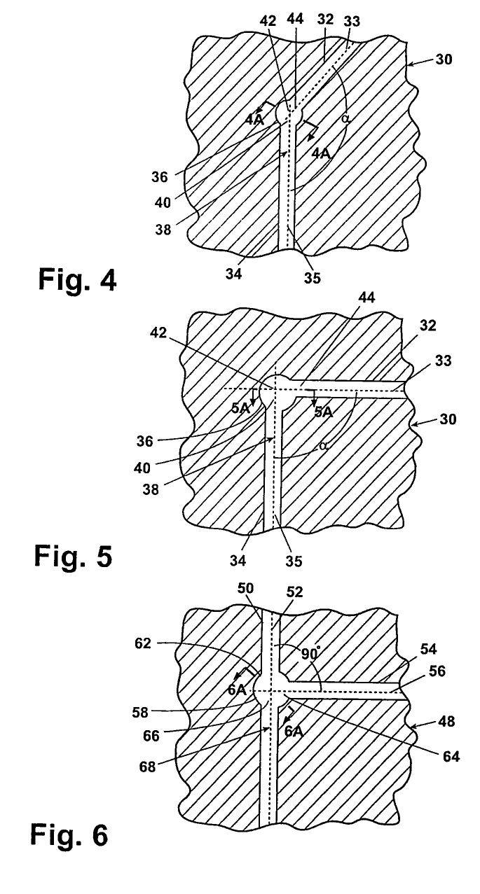

Looking first at FIGS. 4 and 4a, a metal body 30 has drilled into it a first passageway 32 with a longitudinal axis 33 and a second passageway 34 with a longitudinal axis 35 at an angle α relative to each other. Preferably, the passageways 32, 34 will have the same cross-sectional diameter, although it is not essential to the invention. Typically the angle α will be between 90° and 180°. Each passageway 32, 34 fluidly connects to an enlarged cavity 36, defining an intersection between the two passageways, and establishing a conduit 38 through the body 30. The cavity 36 is enlarged in the sense that any measure of its cross section will be larger than a cross sectional diameter of an adjacent passageway 32, 34. Preferably, the cavity 36 is generally spherical. There may or may not be a radius at the junction of a passageway 32 or 34 and the wall of the cavity 36. Thus, a cross sectional view of the body at the cavity 36 is shown as roughly circular in FIG. 4a with a smaller diameter opening 40 to the passageway 34.

Formation of the cavity 36 can be obtained by utilizing the same ECM process used to generate a radius at the intersection of passageways in high-pressure fluid conduits of the prior art. Currently, ECM removes material selectively where a radius is desired. To generate a cavity according to the invention, ECM is used to remove material at the intersection in all directions, thereby generating a roughly spherical cavity. It is believed that the more spherical the cavity, the more evenly stresses introduced by fluid under high pressure are distributed at the intersection. Also, the larger the cavity, the lower the stresses at the intersection. Consequently, there is less likelihood of stress failures occurring at the intersection.

The cavity 36 need not be spherical. It is important that the geometry of the cavity represent roughly the cross section of a passageway 32, 34 at any angle. Also, the center 42 of the cavity 36 should be located at the intersection of the longitudinal axes 33, 35. Thus the opening 40 of passageway 34 will remain circular as if it were breaking into a perpendicular plane. Likewise the opening 44 of the passageways 32 will also be circular at its junction with the cavity 36. Preferably the diameter of the cavity 36 will be at least twice the cross sectional diameter of the passageways 32, 34.

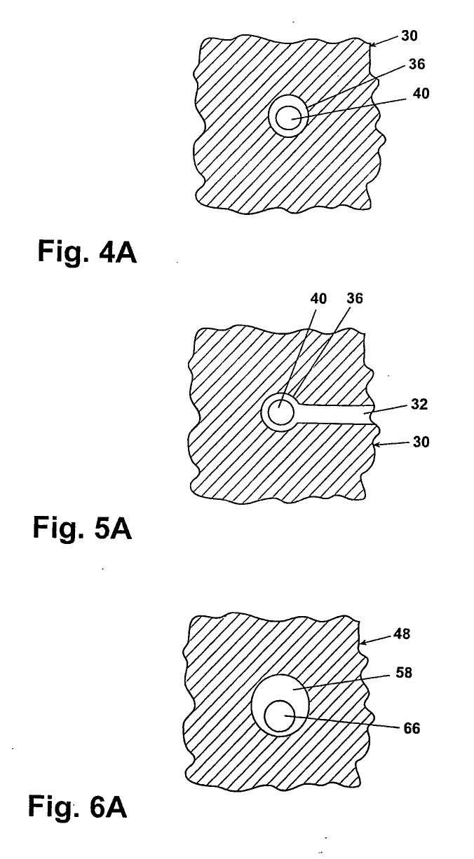

The benefits of the invention are even more apparent when the angle Ca approaches 90° as illustrated in the embodiment of FIGS. 5 and 5a. Here components identical to those of FIGS. 4 and 4a are shown with like numerals. In fact, the only difference between the embodiment of FIG. 4 and that of FIG. 5 is the measure of the angle α. Finite element analysis on a roughly 90° intersection with a spherical cavity according to the invention (as shown in FIG. 5) at a fluid pressure of 29,000 psi (2000 bar) shows generally uniform stress on the walls of the cavity at 550 MPa or 80 KSI, a reduction of over 35% from the stresses projected in a comparable prior art blended intersection with only radiuses between the passageways (as shown in FIG. 2).

FIGS. 6 and 6a illustrate a conduit 48 with a T-intersection according to the invention. Here a first passageway 50 has a longitudinal axis 52 and a second passageway 54 has a longitudinal axis 56 at roughly a 90° angle to the first passageway. A spherical cavity 58 has a center point 60 located at the intersection of the longitudinal axes 52, 56. Thus the passageways present three openings 62, 64, and 66 to the cavity 58 establishing the conduit 68. As explained earlier, the diameter of the cavity 58 is roughly (although not necessarily) twice the diameter of any cross section of a passageway 50, or 54. It is observed that when fluid under high pressure is introduced in the conduit 68, stresses on the wall of the cavity 58 are more evenly distributed and lower than they would be in a comparable radiused intersection without a cavity.

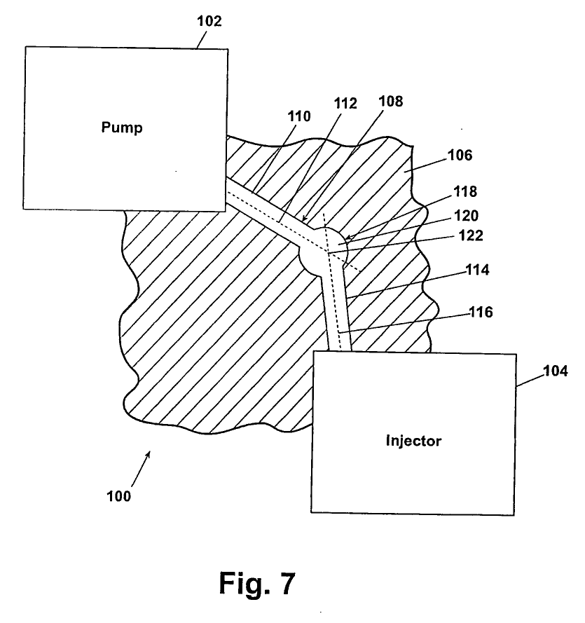

Looking now at FIG. 7, an embodiment of a high-pressure fuel distribution system 100 incorporating a high-pressure fuel conduit according to the invention is shown. The fuel distribution system 100 is one that might typically be found on a diesel engine, for example. The system comprises generally a fuel pump 102 and a fuel injector 104. The fuel pump pressurizes the fuel as it is delivered to the injector 104, and when triggered to do so in the engine cycle, the injector releases the pressurized fuel into a combustion chamber. Delivery of the fuel under high pressure from the pump 102 to the injector 104 is through a body 106 having a high-pressure fuel conduit generally indicated at 108. The high pressure fuel conduit 108 may be formed by drilling a pair of holes; one starting at one side of the body 106 to form a first passageway 110 having a longitudinal axis 112, and another beginning from another side of the body 106 to form a second passageway 114 having a longitudinal axis 116 which meets the first drill hole at an elbow 118. The longitudinal axes 112, 116 intersect at an angle other then 180°. In accord with the invention as shown above in FIGS. 4 and 4a, the elbow 118 is enlarged by ECM to form an enlarged cavity 120, preferably spherical. The center point 122 of the cavity is at the intersection of the longitudinal axes 112, 116 of the first and second passageways 110, 114. When fuel under high pressure moves through the conduit, the stresses exerted on the walls of the cavity 120 by the fuel pressure are not high enough to cause stress fractures in the body 106.

While the invention has been specifically described in connection with certain specific embodiments thereof, it is to be understood that this is by way of illustration and not of limitation, and the scope of the appended claims should be construed as broadly as the prior art will permit.

1. In a body having a conduit formed of a first passageway having a first longitudinal axis and a second passageway having a second longitudinal axis wherein the first and second longitudinal axes intersect at an angle other than 180 degrees, the improvement characterized by:
an enlarged cavity having a center point at the intersection of the first and second longitudinal axes.

2. The improvement of claim 1 wherein the enlarged cavity is generally spherically shaped.

3. The improvement of claim 2 wherein the diameter of the enlarged cavity is at least twice the cross sectional diameter of one of the first and second passageways.

4. The improvement of claim 1 wherein the angle is about 90 degrees.

5. The improvement of claim 4 wherein the diameter of the enlarged cavity is at least twice the cross sectional diameter of one of the first and second passageways.

6. A method of manufacturing a body having a conduit with a first passageway having a first longitudinal axis and second passageway having a second longitudinal axis wherein the first and second longitudinal axes intersect at an angle other than 180 degrees, and an enlarged cavity having a center point at the intersection of the first and second longitudinal axes, comprising the steps of:
drilling the first passageway into the body along a first longitudinal axis;
drilling the second passageway into the body along the second longitudinal axis until the second longitudinal axis intersects the first longitudinal axis;
utilizing electromechanical machining to remove material from the walls of the first and second passageways adjacent the intersection of the first and second longitudinal axes until the enlarged cavity with a center point at the intersection is formed.

7. The method of claim 6 wherein the step of utilizing electromechanical machining includes removing material evenly in all directions to form a spherical cavity.

8. The method of claim 7 further comprising removing material in all directions until the diameter of the cavity is twice the diameter of one of the first and second passageways.

9. A fuel distribution system for an internal combustion engine comprising:
a pump;
an injector;
a fuel conduit in a body, fluidly connecting the pump to the injector, said fuel conduit being adapted for delivery of fuel at high pressure, having a first passageway with a first longitudinal axis and a second passageway with a second longitudinal axis wherein the first and second longitudinal axes intersect at an angle other than 180 degrees; and
an enlarged cavity having a center point at an intersection of the first and second longitudinal axes.

10. The fuel distribution system of claim 9 wherein the enlarged cavity is generally spherically shaped.

11. The fuel distribution system of claim 10 wherein the diameter of the enlarged cavity is at least twice the cross sectional diameter of one of the first and second passageways.

12. The fuel distribution system of claim 11 wherein the angle is about 90 degrees.

13. The fuel distribution system of claim 9 wherein the diameter of the enlarged cavity is at least twice the cross sectional diameter of one of the first and second passageways.

14. A unit fuel injector for an internal combustion engine, the unit fuel injector being of the type comprising a pump, an injector, and a body, characterized by:
a fuel conduit in the body, fluidly connecting the pump to the injector, said fuel conduit being adapted for delivery of fuel at high pressure, having a first passageway with a first longitudinal axis and a second passageway with a second longitudinal axis wherein the first and second longitudinal axes intersect at an angle other than 180 degrees; and
an enlarged cavity having a center point at an intersection of the first and second longitudinal axes.

15. The unit fuel injector of claim 14 wherein the enlarged cavity is generally spherically shaped.

16. The unit fuel injector of claim 15 wherein the diameter of the enlarged cavity is at least twice the cross sectional diameter of one of the first and second passageways.

17. The unit fuel injector of claim 16 wherein the angle is about 90 degrees.

18. The unit fuel injector of claim 14 wherein the diameter of the enlarged cavity is at least twice the cross sectional diameter of one of the first and second passageways.

19. The improvement of claim 1 wherein the diameter of the enlarged cavity is at least twice the cross sectional diameter of one of the first and second passageways.
